(19) United States
(12) Patent Application Publication
(10) Pub. No.: US 2026/0097696 A1
(43) Pub. Date: Apr. 9, 2026

(54) IN-VEHICLE CONSOLE WITH VOICE-RESPONSIBLE CONTROL

(71) Applicant: FCA US LLC, Auburn Hills, MI (US)

(72) Inventors: Mark E Stout, Auburn Hills, MI (US); Stacey L Berger, Auburn Hills, MI (US); Santiago Caceres, Auburn Hills, MI (US); Brandon F Brady, Auburn Hills, MI (US); Travis D Bechtel, Auburn Hills, MI (US)

(21) Appl. No.: 18/910,106

(22) Filed: Oct. 9, 2024

(51) Int. Cl. B60N 2/75; B60K 35/22; B60K 35/26

(52) U.S. Cl. CPC B60N 2/773; B60K 35/22; B60K 35/26; B60N 2/793; B60K 2360/77

(57) ABSTRACT

A vehicle includes a vehicle body, a console and a control system. The vehicle body has a passenger compartment including seats in a front row and one or more other rows. The console is located in the passenger compartment, at least part of the console is a movable portion that is movable from a first position in which the movable portion is received between the two seats in the front row and a second position in which the movable portion is spaced in a fore-aft direction from the two seats in the front row. The control system is associated with the console and has a processor and programming executable by the processor. The control system includes a microphone communicated with the control system to enable detection of verbal inputs received by the microphone.

### FIELD

The present disclosure relates to a vehicle with a control system having a voice-responsive control and a flexible storage system.

### BACKGROUND

Many vehicles include seats arranged in more than one row, with the rows spaced apart within an interior of the vehicle. Conveying items from a passenger in one row of seats to a passenger in another row of seats can be difficult, and may be distractive to vehicle operation if attempted by a driver of the vehicle. In vehicles having three rows of seats, passing items from the front row to a back row can be difficult. Communication between passengers in different rows of seats also can be difficult and distracting. Further, storage within the interior of the vehicle is limited and not secure, and control of vehicle systems from a second or third row of seats is difficult.

### SUMMARY

In at least some implementations, a vehicle includes a vehicle body, a console and a control system. The vehicle body has a passenger compartment including two seats in a front row, the two seats in the front row being spaced apart in a cross-car direction extending between a left side and a right side of the vehicle, and multiple seats in one or more rows spaced from the front row in a fore-aft direction extending between a front and a rear of the vehicle. The console is located in the passenger compartment, at least part of the console is a movable portion that is movable from a first position in which the movable portion is received between the two seats in the front row and a second position in which the movable portion is spaced in the fore-aft direction from the two seats in the front row. The control system is associated with the console and has a processor and programming executable by the processor. The control system includes a microphone communicated with the control system to enable detection of verbal inputs received by the microphone.

In at least some implementations, an actuator is coupled to the movable portion to move the movable portion within the passenger compartment. In at least some implementations, the control system is associated with the actuator to permit control of the actuator via the control system.

In at least some implementations, the control system includes one or both of a first video device and a first audio device, and the programming is arranged so that the control system can provide voice-responsive use of the one or both of the first video device and the first audio device. In at least some implementations, one or both of a second video device and a second audio device are arranged for use by a passenger in the front row. In at least some implementations, the console includes a display and wherein the second video device is communicated with the display. In at least some implementations, the first audio device and the second audio device include both an audio input and an audio output to permit two-way audible communication between the first audio device and the second audio device.

In at least some implementations, the movable portion includes a storage compartment in which an item may be placed for movement with the movable portion.

In at least some implementations, a communication device is communicated with the control system and arranged to permit wireless communication between the vehicle and a remote source. In at least some implementations, the control system is connectable with the internet via the communication device or a remote device that is coupled to the control system.

In at least some implementations, a container is selectively connectable with the movable portion of the console for movement with the movable portion of the console. In at least some implementations, the vehicle has a cargo compartment separated from the passenger compartment by a divider, and the container is movable from the passenger compartment into the cargo compartment through an opening in the divider, and the container is driven by an actuator that is communicated with and controllable by the control system.

In at least some implementations, the control system is communicated with a vehicle system and the programming is arranged to enable voice-activated control of the vehicle system via the control system. In at least some implementations, the vehicle system includes an audio device, a video device, or a heating and cooling system.

In at least some implementations, the control system provides a virtual assistant interface that is usable by a vehicle occupant through voice commands.

In at least some implementations, a vehicle control system, includes a console, a control system, a communications unit, and a backend portion. The console is located in a passenger compartment of the vehicle, at least part of the console is a movable portion that is movable within the passenger compartment. The control system is associated with the console and has a processor and programming executable by the processor, the control system also includes a microphone communicated with the control system to enable detection of verbal inputs received by the microphone. The communications unit is communicated with the control system and is arranged to receive information at the vehicle and to transmit information from the vehicle. The backend portion is in a cloud-based system and includes a processor and memory with programming. The control system includes programming to permit voice-responsive control of one or more vehicle systems, or voice-responsive communication with the backend portion for access to the programming of the backend portion.

In at least some implementations, an actuator is coupled to the movable portion to move the movable portion within the passenger compartment, and control system is associated with the actuator to permit control of the actuator via the control system.

In at least some implementations, the control system includes one or both of a first video device and a first audio device, and the programming is arranged so that the control system can provide voice-responsive use of the one or both of the first video device and the first audio device.

In at least some implementations, the console includes a display and wherein the second video device is communicated with the display.

Further areas of applicability of the present disclosure will become apparent from the detailed description, claims and drawings provided hereinafter. It should be understood that the summary and detailed description, including the disclosed embodiments and drawings, are merely exemplary in nature intended for purposes of illustration only and are not intended to limit the scope of the invention, its application or use. Thus, variations that do not depart from the gist of the disclosure are intended to be within the scope of the invention.

### BRIEF DESCRIPTION OF THE DRAWINGS

FIG. 1 is a perspective view of a vehicle;

FIG. 2 is an overhead view of part of the vehicle showing one or more storage containers in a cargo compartment;

FIG. 3 is a side view of part of the vehicle as in FIG. 2;

FIG. 4 is an overhead view of part of the vehicle showing one or more storage containers in a passenger compartment;

FIG. 5 is a side view of part of the vehicle as in FIG. 4;

FIG. 6 is an overhead view of part of the vehicle showing a console in a second position within the passenger compartment;

FIG. 7 is a side view of the part of the vehicle as in FIG. 6;

FIG. 8 is an overhead view of part of the vehicle showing the console in a third position within the passenger compartment;

FIG. 9 is a diagrammatic view of a vehicle communication system for multiple vehicles;

FIG. 10 is a diagrammatic view of a vehicle that defines part of the system; and

FIG. 11 is a diagrammatic view of the communication system.

### DETAILED DESCRIPTION

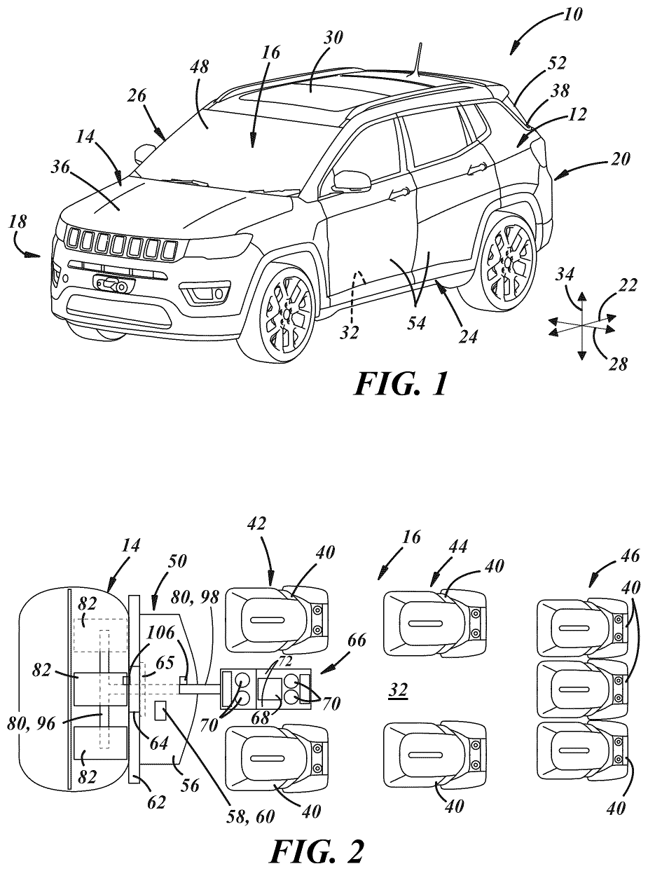

Referring in more detail to the drawings, FIG. 1 shows a vehicle 10 that includes a vehicle body 12 having a cargo compartment 14 and a passenger compartment 16. The vehicle includes one or both of a movable storage container and a movable console that provide flexible storage options usable by more occupants of the vehicle and enabling greater storage space and access to the storage space.

The vehicle 10 includes a front end 18 and a rear end 20 that are spaced apart in a fore-aft direction (shown by arrow 22), left and right sides 24, 26 that are spaced apart in a cross-car direction (shown by arrow 28), and a roof 30 and floor 32 that are spaced apart in a vertical direction (shown by arrow 34). The cargo compartment 14 may be separate from the passenger compartment 16 and typically is provided at one or both of the rear of the vehicle 10 (often called a trunk) and the front of the vehicle 10 (often called a front compartment 14 or frunk). A vehicle deck lid, such as a hood 36 or trunk lid/tailgaite 38 may define part of the cargo compartment 14 which may be separate from or contiguous/open to the passenger compartment 16, in at least some implementations. The deck lid is movable from a closed position to an open position to permit access to the area beneath the deck lid, which may include the cargo compartment 14. While not limited to electric vehicles, certain electric vehicles have considerable space available in the front compartment 14 or frunk and may be readily adapted for storage as noted herein.

Referring to FIGS. 2-5, the passenger compartment 16 is part or all of a vehicle interior and includes seats 40 for vehicle 10 occupants. In the example shown, a front row 42 of seats 40 includes two seats, e.g. for a driver and front passenger, a second row 44 with two seats 40 spaced apart in the cross-car direction, and a third row 46 having three seats 40. Any desired seating configuration may be used. The passenger compartment 16 may be defined at least in part by the roof 30 (e.g. interior headliner), floor 32, a windshield 48 (FIG. 1) and an instrument panel 50 at a front of the passenger compartment 16, a rear window 52 (FIG. 1) and/or body panel at a rear of the passenger compartment 16, and one or more doors 54 (FIG. 1) at the left and right sides 24, 26 of the vehicle 10, and associated vehicle structural components, such as pillars that extend to and are coupled to the roof.

The instrument panel 50 includes one or more interior trim pieces 56 and one or more displays 58 on which vehicle operational information is provided (e.g. gauges for speed, engine temperature and engine rpms, and icons for warning messages, etc.) and via which a human-machine interface (HMI) 60 may be provided. The HMI 60 may be part of an infotainment system 61 by which various vehicle controls may be implemented or selected by a user, such as by a touch screen or other inputs like buttons or dials, and by which a remote device 63 may be connected (e.g. a smart phone) and audio (e.g. radio/sound system) and other devices or systems may be accessed for user control. On or near the instrument panel 50, one or more drive controls may be provided, such as a steering input/wheel, a transmission/powertrain gear selector, an accelerator input and a brake input. The instrument panel 50 may define or be connected to a divider 62 that spans in the cross-car direction between the left and right sides 24, 26, in the vertical direction from the floor 32 to the windshield 48, and is located in the fore-aft direction between the cargo compartment 14 and the passenger compartment 16. The divider 62 may be, in at least some implementations, a structural member of the vehicle 10, sometimes called a firewall and may be used to separate powertrain components in the front compartment 14 from the passenger compartment 16 and to mount or passthrough various vehicle 10 components within the front compartment 14. The divider 62 may define at least part of the passenger compartment 16, in at least some implementations.

To permit at least selective communication between the cargo compartment 14 and the passenger compartment 16, an opening 64 is provided in the divider 62. The opening 64 may be located below the instrument panel 50 or through part of the instrument panel 50. In at least some implementations, a cover 65 is provided that is movable relative to the opening 64 to selectively close and open the opening 64.

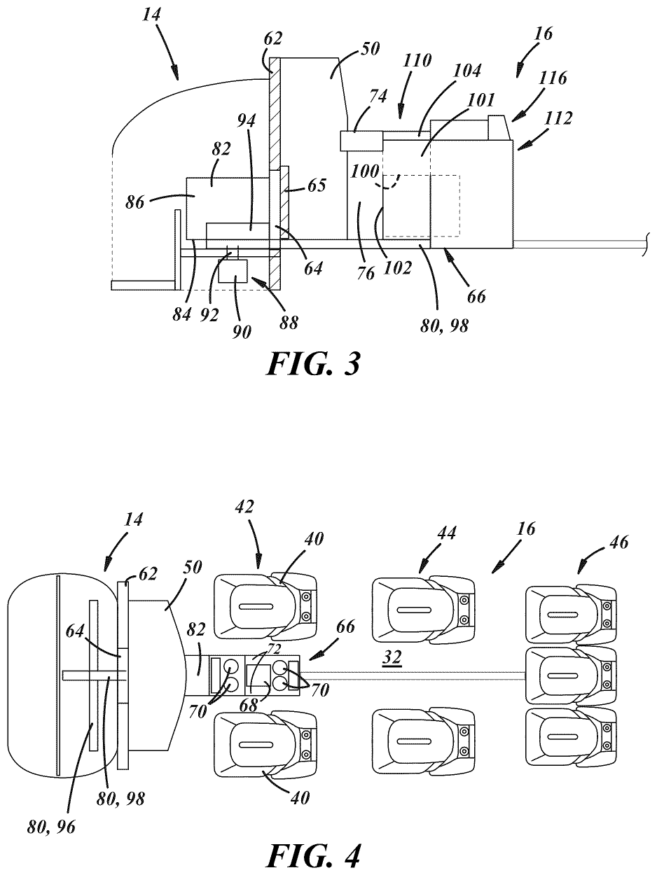

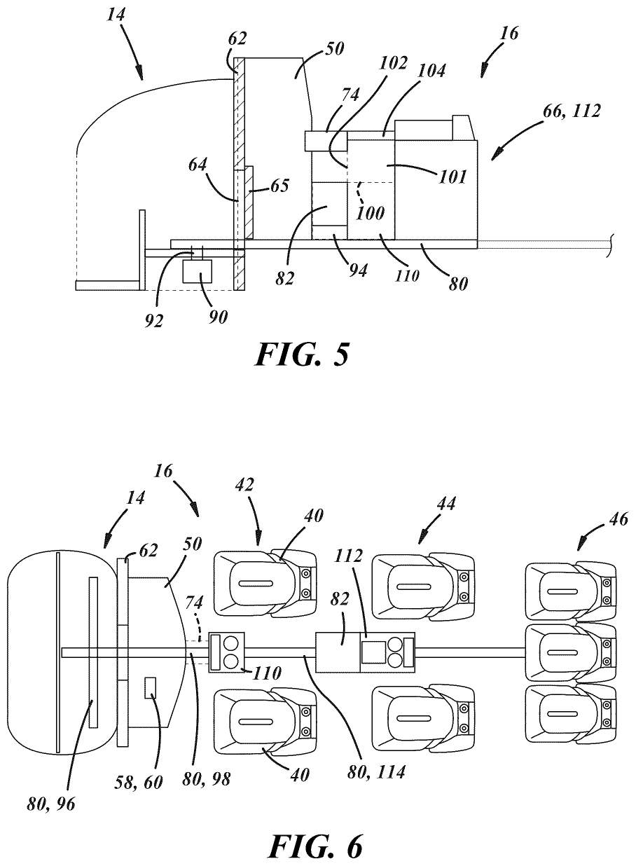

The vehicle 10 may include a console 66 that may, for example, have one or more storage compartments 68, one or more cupholders 70, an armrest 72 and other features or components as desired. The console 66 may be located between two seats 40, such as between the front two seats, as shown in FIGS. 2-5. In this arrangement, the console 66 may be generally centered in the cross-car direction and may be spaced from the instrument panel 50 in the fore-aft direction. The console 66 could be part of the instrument panel 50, or it may be coupled thereto by a bridge 74, such as is shown in FIGS. 3 and 5 and which may define a stationary portion of the console. The bridge 74 may provide some of the features noted (e.g. cupholders or storage areas) and may be spaced vertically from the floor 40 and arranged near an upper portion of the console 66. A space 76 (FIG. 3) may be provided between a lower surface of the bridge 74 and the floor 40, and things may be stowed in the space. Sidewalls or the like may be provided to contain items and keep the items out of footwells in front of the seats 40.

To contain stowed items and to facilitate moving items between the cargo compartment 14 and the passenger compartment 16, the vehicle 10 may include a container path 79 that extends through the opening and between the cargo compartment 14 and at least partly into the passenger compartment 14. A track 80 may be provided along at least part of the path 79, and the track 80 may extend through the opening 64 and has part located in the cargo compartment 14 and/or part in the passenger compartment 16. The track 80 may be of any suitable construction and may be continuous or discontinuous along its length which may be oriented in the fore-aft direction. The track 80 may extend into the passenger compartment 16 and to, partly into or adjacent to the console 66. While shown as an elongated and generally flat member received on the floor of the vehicle 10, the track 80 may instead or in addition include sidewalls or guiderails spaced apart in the cross-car direction.

To facilitate transferring things between the cargo compartment 14 and the passenger compartment 16, a container 82 is associated with the track 80 and is movable along the track 80. As shown in FIG. 3, the container 82 has a body which may include a bottom wall 84 and sidewalls 86 extending vertically from the bottom wall 84. The container 82 may be open at its upper end or closed, such as by a removable or movable cover or lid. Items may be placed in and contained by the container 82, and removed thereform, as desired. As shown in FIGS. 2 and 3, the container 82 has a first position in which the container 82 is located within the cargo compartment 14 and, as shown in FIGS. 4 and 5, a second position in which the container 82 is located within the passenger compartment 16. The container 82 may be of any suitable size and shape and is designed to pass through the opening 64 when it moves between the first and second positions, and the container 82 may be stopped between those positions in one or more intermediate positions, as desired.

The container 82 may be manually moved along the track 80 or the container 82 may be coupled to and driven by an actuator 88. In at least some implementations, the actuator 88 includes a motor 90 and a drive member 92 that is driven by the motor. For example, the motor 90 may be fixed in the vehicle 10, such as in the cargo compartment 14 or otherwise in the front compartment 14, and the motor 90 the drive member 92 may be a power transmission member, such as a belt, chain or cable. The belt, chain or cable may be driven by a gear or wheel that is rotated by the motor 90, or otherwise driven, as desired. To move the container 82, the container 82 may be coupled to the drive member 92 for movement as the drive member 92 moves. In at least some implementations, as shown in FIGS. 3 and 5, a shuttle or carrier 94 is provided that is coupled to the drive member 92, and the container 82 is connected to the carrier 94 so that both the carrier 94 and container 82 are driven by the motor 90. Other arrangements may be used, as desired. For example, the motor 90 may be carried by the container 82 and may directly rotate wheels coupled to the container 82 to move the container 82 relative to the vehicle 10. The wheels may move along the vehicle floor, or along the track 80, or both.

In at least some implementations, the container 82 may be movable within the cargo compartment 14 such that the container 82 has positions in which the container 82 is not aligned with the opening 64. That is, the container 82 may be offset in the cross-car direction, for example, from the opening 64. To facilitate such movement, as shown in FIGS. 2 and 4, the track 80 may include a second portion 96 that is received in the cargo compartment 14 and which guides and enables movement of the container 82 in the cross-car direction. In the example shown, the second portion 96 is provided at an end of the first portion 98, which extends into the passenger compartment 16. This lateral or cross-car movement of the container 82 can help to move the container 82 out of the center of the cargo compartment 14.

Additionally, the movement in a second direction enables more than one container 82 to be received in the cargo compartment 14, and selectively aligned with and movable through the opening 64, as shown in FIG. 2. In this way, a first container 82 may be moved in the cross-car direction out of the way of the opening 64 and spaced from the end of the first portion 98 of the track 80, to permit a second container 82 to be aligned with the opening 64 and ready for movement along the first portion 98 of the track 80 (e.g. into the passenger compartment 16). The second portion 96 of the track 80 may accommodate movement of a container 82 in one or both directions away from the opening 64 (e.g. toward the right and/or left sides of the vehicle 10). A separate actuator may be provided to move the containers 82 in the cross-car direction. The containers 82 may be moved along the second portion 96 on a carrier or shuttle 94, which may be arranged for movement along both the second portion 96 and the first portion 98 of the track 80, in a least some implementations. In this way, each container 82 may be received on a separate carrier or shuttle 94. The containers 82 may be releasable from the carriers or shuttles 94 and track 80 to permit the containers 82 to be removed from the vehicle 10, if desired.

To facilitate loading the containers 82 from within the passenger compartment 16 or retrieving items from the containers 82 from within the passenger compartment 16, in at least some implementations, the container 82 meshes or cooperates with the console 66. In the embodiment shown, and with reference to FIGS. 3 and 5, the console 66 includes a void 100 in a forward most or forward-facing side 102 of the console 66. When the container 82 is in the second position, the container 82 is received at least partially in the void 100. The container 82 may define part or all of a storage compartment of the console 66, and it may be accessed by opening a lid or cover 104 on the console 66 that overlies a console opening 101 or chamber leading to the void 100.

In at least some embodiments, the container 82 may be moved to the second position while the vehicle 10 is in use, to permit items to be stored in and retrieved from the console 66. This may occur automatically, if desired, when the vehicle 10 is turned on or otherwise set for use. Additionally, when the vehicle 10 is turned off or otherwise set for non-use, the container 82 may be moved into the cargo compartment 14 so that the container 82 and the contents therein are not accessible from within the passenger compartment 16. This may also be done automatically, if desired. Or this may be done as commanded by a user (e.g. via the HMI). This may be desirable to deter thieves from breaking into the passenger compartment 16 in search of items left in the passenger compartment 16.

In this regard, the cover 65 for the opening 64 may be closed other than when the container 82 is moving therethrough. The cover 65 may be opened manually, or automatically by an actuator. Proximity switches or sensors 106 (FIG. 2), for example, may be used to control movement of the cover 65 to permit a container 82 to pass through the opening 64 and to close the opening 64 after a container 82 moves through the opening 64. The cover 65 could be mechanically driven by movement of the container 82 relative thereto, if desired. By way of a non-limiting example, the container 82 may as it moves near the cover 65 displace a lever or cam that causes movement of the cover 65, and the system may be spring loaded to return to a starting position after such movement. Of course, other arrangements may be used, as desired. This may desirable for security reasons as well as for noise and environment isolation from the passenger compartment 16.

Further, the cargo compartment 14 may be fully enclosed or lockable such that opening the deck lid does not provide direct access to the cargo compartment 14 and containers 82. In this way, items may be stored securely when the vehicle 10 is not in use, or if the vehicle 10 is to be used by another person, for example without limitation, a valet who may drive the car to park it. Prior to giving the vehicle 10 to the valet (or other person), the container 82 may be moved into the cargo compartment 14. Further, the system can be set up to prevent others from commanding the container(s) 82 to move out of the cargo compartment 14, for example, by a lock/key or password/secure identification (e.g. fingerprint reader) type arrangement.

In addition to or instead of having a storage container 82 that is movable between the cargo compartment 14 and the passenger compartment 16, at least part of the console 66 may be movable within the passenger compartment 16, as generally shown in FIGS. 6-8. In the example shown, the console 66 includes a first portion 110 that may be fixed and not movable, and a second portion 112 that is movable relative to the first portion 110.

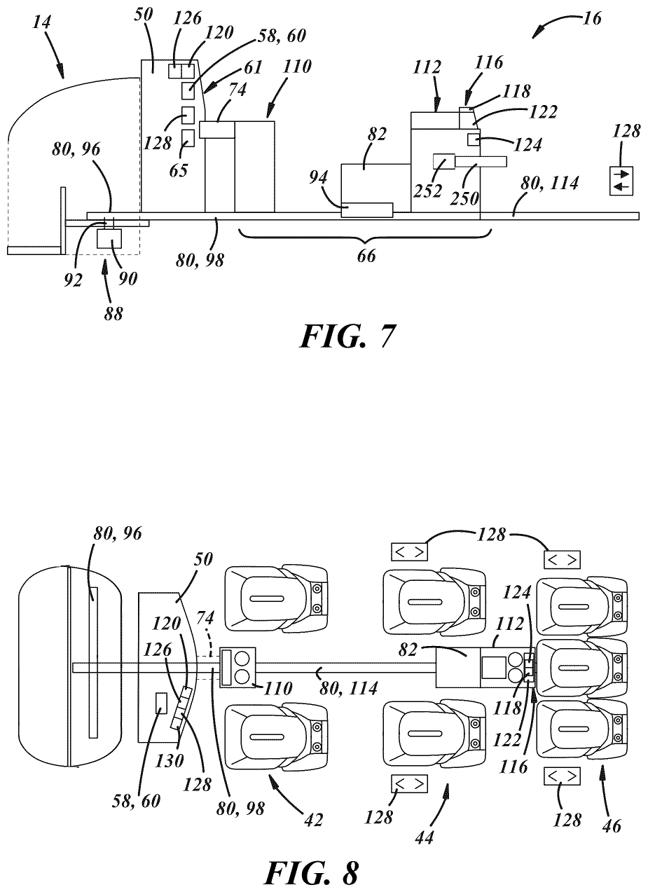

In at least some implementations, the void 100 in the console 66 is a passage through the first portion 110 of the console 66. The container 82 can then pass through the first portion 110 of the console 66, and can be connected to or otherwise movable with the second portion 112 of the console 66. Even without the container 82, the console 66, such as the second portion 112 thereof, can move relative to the front row of seats, in the fore-aft direction. In this way, the container 82 may be selectively coupled to the console 66, such as by an electromechanical latch, movable hook or the like. As shown in FIGS. 6 and 7, the console 66, with or without the container 82, can move to or toward the second row 44 of seats 40 for use of the console 66 by occupants in the second row 44. At least part of the second portion 112 of the console 66 may be overlapped, in the fore-aft direction, with the seats 40 in the second row 44. As shown in FIG. 8, in at least some implementations, the console 66 can move to a position in front of the third row 46 of seats 40, again, with or without the container 82. In this position, some or all of the second portion 112 of the console 66 may be located between the second row 44 and third row 46 of seats, in the fore-aft direction.

In the example shown, the track 80 includes a third portion 114 that extends beyond the console 66 in the fore-aft direction, and between the second row 44 of seats and to or toward the third row 46 of seats. The third portion 114 may be an extension of and contiguous with the first portion 98 of the track 80, if desired. In this way, the drive member 92 of the actuator 88, at least when an elongated member such as a belt, rotatable or stationary screw (e.g. along which the shuttle travels without rotation about the screw), chain or cable, can extend along at least part of the third portion 114 of the track 80. The second portion 112 of the console 66 can be selectively connectable to the drive member 92 and moved along the track 80 when so connected and when the drive member 92 is driven by the motor 90. In other implementations, a motor may be associated with the second portion 112 of the console 66, and may drive rotary components, like wheels, sprockets (e.g. with projections that engage spaced holes in the track) or the like, to move the console 66 along the third portion 114 of the track 80.

The movable console 66/112 permits many functions. For example, a person in one row of seats can place items on the console 66 for delivery to a person in another row. The console 66 can provide cupholders 70 and storage bins 68 within reach of passengers in the various rows 42, 44, 46 of seats 40. Further, if the console 66 includes a HMI 116, for example, to control in-vehicle displays, movies, gaming or the like), heating and cooling (e.g. for rows other than the front row of seats) or audio equipment, moving the console 66 can permit passengers in different rows to have access to such HMI controls 116. Further, if the container 82 moves with the console 66, then passengers in the second or third row 44 or 46 of seats can have access to the container 82 and can take items out of or place items in the container 82 for delivery to a passenger in a different row of seats, or into the cargo compartment 14, if a container 82 is also available. To facilitate passenger ingress and egress from the vehicle 10, the second portion 112 of the console 66 can be moved to its first position, adjacent to the front row 42 of seats, as desired.

In at least some implementations, as shown in FIGS. 7 and 8, a video output device 118, e.g. a camera, may be provided on the movable console 66 and the camera 118 may provide a video feed to a display 58 on the instrument panel 50, for example. This may enable a person in the front row 42 of seats to see at least part of the passenger compartment 16 that is behind them, without having to turn around. In one example, the camera field of view may include the seats 40 in the second row 44 and/or third row 46, and in particular, a child's seat, to enable a driver or other front row passenger to monitor a child in that seat. For two-way viewing, another video device/camera 120 may be provided with a field of view including the front row 42 of seats, and in particular, a driver's seat. The console 66 may include a display 122 and one or both cameras 118, 120 may provide a video feed to the display 122 (as well as to the instrument panel display 58 or other display in the vehicle). Audio devices 124, 126 may have inputs and outputs (e.g. microphones and speakers) and may also or instead of the cameras be provided at both of the console 66 and instrument panel 50 (or other location accessible by front row passenger(s)) to facilitate two-way audible communication between passengers in different rows of seats. In this way, the movable console 66 may include video and/or audio devices that enable a video and/or audio interface with passengers in different rows of seats.

Suitable controls 128 to cause movement of the console 66 (e.g. forward and backward buttons or inputs) may be provided in one or more desired locations within the passenger compartment 16. The controls 128 may provided near the front row 42 of seats, for example on the instrument panel 50, or on the first portion 110 of the console 66, to enable control of the location of the console 66 by a passenger in the front row 42 of seats. Additional controls 128 may be provided near the seats in the other rows 44, 46 of seats, if desired, so passengers in those seats can command movement of the console 66. In such implementations, it may be desirable to have an override switch 130 located for access by passengers in the front row 42 of seats so that a passenger in the front row can prevent passengers in the second or third rows 44, 46 from moving the console 66 when such movement is not desired.

In addition to user commanded motion of the console 66, some movement of the console 66 may occur automatically, if desired. For example, when the console 66 is not in the first position, the system may actuate the motor to return the console 66 to the first position, for example, when the vehicle is powered off. This may move the console 66 out of an aisle between the second and/or third row 44, 46 of seats, and facilitate passenger ingress and egress from the vehicle 10.

The systems provide a unique storage solution that enables easy transfer of things between a passenger compartment 16 and a cargo/storage compartment 14, and/or transfer of things between passengers in different rows of the vehicle. This may facilitate having more things accessible within the vehicle, such as with multiple containers that may be selectively brought into the passenger compartment 16 from the cargo compartment. Increased security is also achievable by enabling stored items to be removed from the passenger compartment 16 and located in a secure area outside of the passenger compartment 16 when not needed, or when the vehicle is parked or might be driven by another person. In at least some implementations, the console 66 may be used to store items that are more frequently used or needed in use of the vehicle, and the cargo compartment may be used to store items less frequently needed or used, and to securely store things when the vehicle is not in use, or is in a valet or similar mode. Further, the movable console 66 can include video and/or audio devices to facilitate communication by passengers in different rows within the passenger compartment 16.

The vehicle may also include or communicate with a control system including a processor, memory and programming to provide interactive, voice-responsive, virtual assistance to vehicle occupants. The control system may be arranged to permit wireless access to one or more remote data sources, such as by cellular, wi-fi or other connection. The control system may be communicated with a remote device 63 within the vehicle, such as a smart phone, computer or tablet, that is itself wirelessly connected to the one or more remote data sources, to enable the control system to access the remote data sources via the remote device 63.

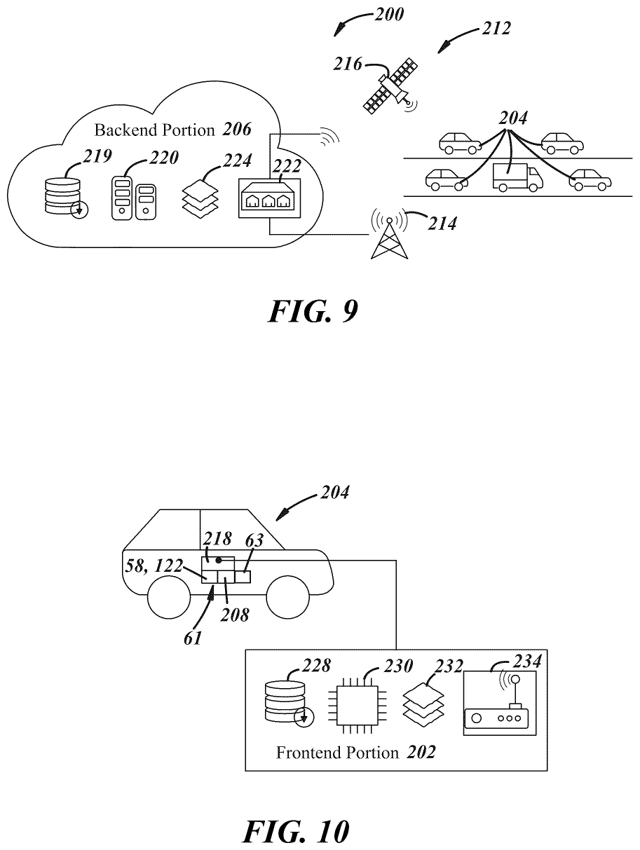

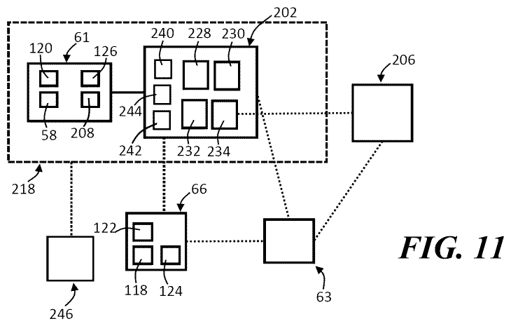

The control system 218 may be part of a vehicle communication system 200, such as is shown in FIG. 9. The communication system 200 may include a frontend portion 202 with one or more network vehicles 204 that are in communication with a backend portion 206 via one or more communication devices and suitable communication protocols. The network vehicles may include in-vehicle infotainment (IVI) systems 61 (FIGS. 7, 10 and 11) that utilize a combination of software and hardware components to provide a wide range of information, system controls and entertainment, as is known and noted herein. As diagrammatically shown in FIGS. 10 and 11, the IVI system 61 may include one or more display screens 58, 122 and a user interface 208. The user interface 208 may include various inputs, like buttons, switches, touch-sensitive areas of the displays 58, 122, audio devices 124, 126 (microphone(s) for audio or voice commands and inputs, and speakers), and the like.

With reference to FIGS. 9-11, the vehicle communication system 200 may be a cloud-based system that may receive incoming information from individual ones of the network vehicles 204 and send outgoing information to one or multiple network vehicles 204, where the outgoing information may include mass communications (i.e. notifications) that are the same for multiple vehicles or individual communications that are each specific to the vehicle to which each individual communication is sent. The system 200 may gather real-time information from network vehicles 204, may gather information at determined intervals or times, and the system 200 may analyze the information and determine if a notification or other communication should be sent to one or more vehicles as noted in more detail later, and the system 200 may receive and handle information requests from network vehicles 204 to enable, among other things, a virtual assistant type interface within the network vehicles 204.

The term “real-time”, as used herein, does not strictly require that such information and notifications be generated, sent, received and/or otherwise processed at the exact moment when their underlying events or conditions occur in order to be “real-time”. Rather, these terms broadly include any such information and notifications that are generally contemporaneous with their underlying events or conditions so that the environmental conditions information and notifications are still relevant or accurate in the context of the present system and method (e.g., within seconds, minutes or even hours of their underlying events or conditions). Further, information may be sent from or a vehicle as during use of the vehicle, or before or after use of the vehicle.

System 200 may deliver hosted services via the internet and/or other communication networks and may be structured as a public, private or hybrid cloud, for example. According to one non-limiting example, vehicle communication system 200 is structured as a private cloud and generally includes the backend portion 206 and the frontend portion 202 that is distributed across a fleet of network vehicles 204, where each network vehicle 204 is capable of obtaining and providing information as well as communicating with the backend portion 206 over a secure communications network 212 (e.g., secure vehicle-to-cloud (V2C) network), and/or communicating with other vehicles via a vehicle-to-vehicle (V2V) connection. The secure communications network 212 may include a cellular-based network 214, a satellite-based network 216, a city-wide WiFi-based network, some other type of communications network and/or a combination thereof. Although only a few network vehicles 204 are shown in the drawings, it should be appreciated that system 200 may interact with a large fleet of vehicles that can include dozens, hundreds, thousands or even more vehicles. System 200 may be used with any vehicles, including (but not limited to) passenger, commercial and/or public transportation vehicles sold in any geographic area.

Backend portion 206 may include any suitable combination of software and/or hardware resources typically found in a backend of a cloud-based system, as best illustrated in FIG. 1. The backend portion 206 may be responsible for managing some of the programs and algorithms that run applications on the frontend portion 202, such as those that request, obtain and optionally analyze information of and from the network vehicles 204. It is noted that the data/information used to formulate notifications and information for vehicles may be analyzed by control systems 218 and processors on-board a network vehicle 204 or by the backend portion 206 or both, as desired. The backend portion 206 may be managed or controlled by the vehicle manufacturer and can be part of a larger cloud-based system that the vehicle manufacturer uses to communicate and interact with a large fleet of vehicles for a multitude of purposes. For example, the backend portion 206 may include or communicate with emergency alert systems, such as those that provide Amber alerts or other missing persons alerts, or law enforcement systems that may provide and receive information regarding vehicles of interest to them.

The backend portion 206 may include any suitable combination of software and/or hardware resources including, but not limited to, components, devices, computers, modules and/or systems such as those directed to applications, service, storage, management and/or security (each of these resources is referred to herein as a “backend resource,” which broadly includes any such resource located at the backend portion 206). In one example, the backend portion 206 has a number of backend resources including data storage systems 219, processors or servers 220, communication systems 222, programs and algorithms 224, as well as other suitable backend resources. It should be appreciated that backend portion 206 is not limited to any particular architecture, infrastructure or combination of elements, and that any suitable backend arrangement may be employed.

Frontend portion 202 may include any suitable combination of software and/or hardware resources typically found in a frontend of a cloud-based system, as shown in FIG. 10, and is generally responsible for sending information to the backend portion and receiving notifications, programs, instructions and the like from the backend portion 206. Depending on the particular arrangement, the frontend portion 202 may also be responsible for gathering camera, sensor, location and/or other data from devices on the vehicle 204, and sending such information to the backend portion 206. The frontend portion 202 is typically responsible for running the applications that interface with the users in the different vehicles 204, and for interfacing with the programs and algorithms 224 of the backend portion 206. The frontend portion 202 may also be managed or controlled by the vehicle manufacturer and can be part of a larger cloud-based system that the vehicle manufacturer uses to communicate and interact with a large fleet of vehicles for various purposes, as mentioned above. The frontend portion 202 may be distributed across one or more vehicles 204 and may include any suitable combination of software and/or hardware resources including, but not limited to, components, devices, computers, modules and/or systems (each of these resources is referred to herein as a “frontend resource,” which broadly includes any such resource located at the frontend portion 202).

In one example, the frontend portion 202 has a number of frontend resources including a vehicle control system 218 having one or more vehicle electronic module(s) installed in vehicles 204, which may include some combination of a data storage unit 228, an electronic control unit and/or processor(s) 230, programming/applications 232, a communications unit 234 (e.g., one that includes a telematics unit and/or other communication devices with a receiver by which information is received at unit 234 and a transmitter by which information is sent from the unit 234), as well as other suitable frontend resources. The control system 218 may be or include a telematics box module (TBM), a telematics control module (TCM), a body control module (BCM), an electronic control unit (ECU), an infotainment control module, or any other suitable module known in the art. It is not necessary for the preceding units to be packaged in a single vehicle electronic module, as illustrated in FIG. 2; rather, they could be distributed among multiple vehicle electronic modules, they could be stand-alone units, they could be combined or integrated with other units or devices, or they could be provided according to some other configuration. It should be appreciated that frontend portion 202 is not limited to any particular architecture, infrastructure or combination of elements, and that any suitable frontend arrangement may be employed.

In order to perform the functions and desired processing set forth herein, as well as the computations therefore, the control system 218 may include, but is not limited to, one or more controller(s), control unit(s), processor(s), computer(s), DSP(s), memory, storage, register(s), timing, interrupt(s), communication interface(s), and input/output signal interfaces, and the like, as well as combinations comprising at least one of the foregoing, as generally described with regard to the frontend portion 202. For example, the control system 218 may include input signal processing and filtering to enable accurate sampling and conversion or acquisitions of such signals from communications interfaces and sensors. As used herein the terms control system 218 may refer to one or more processing circuits such as an application specific integrated circuit (ASIC), an electronic circuit, a processor (shared, dedicated, or group) and memory that executes one or more software or firmware programs, a combinational logic circuit, and/or other suitable components that provide the described functionality. The control system 218 may be distributed among different vehicle modules, such as an infotainment system control module, engine control module or unit, powertrain control module, transmission control module, and the like, if desired, and the memory and one or more processors may be one or both integrated into the vehicle 204 or remotely located and wirelessly communicated to the vehicle 204, as desired.

The term “memory” or “storage” as used herein can include computer readable memory, and may be volatile memory and/or non-volatile memory. Non-volatile memory can include, for example, ROM (read only memory), PROM (programmable read only memory), EPROM (erasable PROM), and EEPROM (electrically erasable PROM). Volatile memory can include, for example, RAM (random access memory), synchronous RAM (SRAM), dynamic RAM (DRAM), synchronous DRAM (SDRAM), double data rate SDRAM (DDR SDRAM), and direct RAM bus RAM (DRRAM). The memory can store an operating system and/or instructions executable by a processor or controller or the like to enable control or allocate resources of a computing device.

To facilitate use by occupants in different areas of the passenger compartment, the control system 218 may be carried by or accessible from the movable console 66. In this regard, the control system 218 may be a single control unit or multiple units, as noted herein. For example, one part of the control system 218 may be provided in the movable console 66 and another part of the control system 218 may be provided in or accessible from the instrument panel 50 or dashboard or the stationary console 74 or portion of the console.

The control system 218 may include a speech analyzer 240 and an implementer 242. The speech analyzer 240 may interface with the audio devices 124, 126, particularly the inputs thereof, and apply known speech recognition techniques to spoken words detected and communicated with the control system 218. For example, speech to text conversion can occur and the text then analyzed by the programming that may define the speech analyzer 240 to determine the speech content. The programming may include an initializer 244, which may be a wake-up word or action (e.g. actuation of a physical input) that may be required so that the control system 218 actively monitors for speech only after the initializer 244 is detected and not all the time, although other implementations may be used as desired. Examples of initializers in existing systems outside of a vehicle include “hey Siri” for iOS devices and “Alexa” as a default initializer word for Amazon® devices.

Various techniques for confirming a request or command detected by the speech analyzer 240 are known and may be used to enable a wide range of spoken words to be converted to known requests or commands. For example, if the control system speech analyzer 240 detects the word “food”, queries relating to food can be generated by the control system 218 and responses provided by the control system 218 to a user can be analyzed to improve the accuracy of the information returned by the control system 218. By way of non-limiting examples, the control system 218 may respond with a text or audio query in response to “food” of: “would you like information about nearby restaurants? ” or “what type of food are you interested in? ” The responses may be in the form of text provided on the display(s) 58, 122, spoken or provided audibly via suitable text to speech programming and via the audio device(s) 124, 126, or both.

The implementer 242 may be communicated with one or more internal sources and external or remote sources. The internal sources may be used, for example, to enable control of vehicle-based systems 246. By way of non-limiting examples, the implementer 242 may be used to change a radio station or AV source being used, control a rear-seat entertainment system from a seat behind the front row, change HVAC settings (which may have separate controls for front seat passengers and those in the seats behind the front row), turn on or off lights, display images from a vision sensor or camera, actuate different drive modes (e.g. sport, eco, track, etc), access software applications stored in the vehicle or accessible by a device in the vehicle (e.g. a connected smart phone). The internal sources may also provide information relating to vehicle operation, such as but not limited to information from vehicle sensors, navigation program(s), and the like. Phone functions like cellular calls, texting, calendars, and the like can be accessed, and other requests, commands and interactions can be managed through the internal sources, in at least some implementations. Thus, the implementer may be communicated with one or more controllers of the vehicle to enable actuation or control of various vehicle systems 246. Certain vehicle systems 246 and applications may be controlled, for example, by the infotainment system 61 which may include one or more controllers.

The external sources may be internet or cloud-based systems accessible by one or more applications. The external sources may provide any desired information or functionality generally available via the internet, for example. Requests for weather information, restaurant information, scores of sports games, and virtually anything else can be accessed via the remote sources. It is noted that the internal sources may also have some information stored therein such as daily or weekly weather forecasts, and other information that might be more frequently requested. The control system 218 can thus be used for a wide range of information requests, tasks and commands.

In addition, the control system 218 is coupled to the actuator 88 for the storage system and/or the movable console 66, which may be called an internal source. In this way, by verbal command or request, a user can cause the actuator 88 to move the container 82 and/or the movable portion of the console 66. For example, a user can command the movable console 66 to move within the passenger compartment 16 by uttering suitable words or phrases. Using “Stella” as an initializer 244, a user may say “Stella, bring me the storage container from the front storage compartment” or “Stella, move the console to the back row of seats”, “Stella, move the container [or console] towards me” (where the location of the spoken words may be determined by the microphone at which the spoken words are loudest, or by other means), “Stella, move the container to the trunk”, “Stella, secure [lock] the storage container in the storage compartment”, or the like. The control system 218 will recognize and analyze the speech and determine instructions to cause the desired result. The instructions will be communicated with the controller that drives the actuator 88, and the actuator 88 will cause movement of one or both of the container 82 or console 66, as appropriate. The system 218 may seek confirmation that the requested action has been taken, and that can be answered with a verbal response where an affirmative response ends the action and a negative or other response leads to a request for further command or clarification of the action requested, for example.

Further, as noted above, the vehicle may include audio devices 124, 126 and video devices (e.g. displays 58, 122, and cameras 118, 120) to permit one-way or two-way viewing and/or communication options. The control system 218 may, upon verbal or physical input actuation, control the audio and video devices to initiate or wake-up, and permit the requested communication. For example, messages may be transferred between the movable console 66 and the audio or video devices accessible by occupants of the front row 42 of seats 40, and the messages may be audible, text or audio and video based sent as discrete files or streamed, live interaction via the devices. By way of one non-limiting example, an occupant in the second row 44 or third row 46 could locate a restaurant or other point of interest, which may be done with the assistance of the control system 218 and virtual assistant programming. The occupant could then send, via the control system 218, details about the point of interest to the infotainment system 61 for display and review by a front row occupant. The information may include navigation instructions to the point of interest so that, if accepted by the front row occupant, a navigation program is initiated and populated with a destination of the point of interest for ease of navigation to the point of interest.

As previously noted, the console 66 may include one or more displays to allow a user to interact with and control the system, and the console 66 may serve as a physical extension of the control system 218 including its virtual assistant capabilities and programs. The display(s) 122 may be fixed and not movable relative to the console, or the display(s) 122 may include a mechanism to allow it/them to move vertically, and/or to articulate to allow a display to face the user for improved ergonomic access. Further, the display 122 may be an integral part of the vehicle 10 or the console 66, or the console 66 may accept a remote device 63 and use the display of the remote device 63 in addition to or instead of a display on the console 66. This display or displays 58, 122 will allow users to access information from the vehicle's infotainment system, share digital content such as music playlists and movies, suggest and facilitate interactive games, and provide the human-like interactions/responses characteristic of a virtual assistant programming.

In at least some implementations, as noted above, the control system 218 includes software/programming and an HMI 61/user interface 208 that can be displayed to users through multiple locations in the vehicle 10. The control system 218 can leverage the versatility of the movable console 66 to extend the control system's capabilities to occupants throughout the vehicle. In at least some implementations, the control system 218 enables vehicle communications and notifications to be provided to occupants of the vehicle, such as through the HMI provided by or with the movable console 66. The control system programming may provide graphics and be a recognizable companion/feature of the vehicle, and may create a welcoming environment for vehicle occupants, listen to their verbal inputs, and respond in a helpful manner. The control system 218 can carry out tasks to decrease the workload on the user or assist them with their journey and use of the vehicle and its features.

The control system 218 can activate and control various vehicle functions automatically to improve occupant comfort and enjoyment. These functions may include, but are not limited to, window actuation, adjusting HVAC settings, playing music or other audio/visual/entertainment content, or configuring cabin seating and storage. In the example of seating, one or more vehicle seats 40 may be moved from a first position to a second position by a motor, and the control system 218 may actuate the motor to move a seat 40. This may change the location of the seat and/or move a seat between a stowed position in which a person cannot use the seat, to an active position in which a person can use the seat. The control system 218 may coordinate the exchange of physical items in the vehicle between occupants in different areas of the passenger compartment 16, as well as between storage locations and the passenger compartment 16 via the movable console 66 and movable container 82 system. These physical systems can serve as physical extensions of the virtual assistant programming, such as by carrying AV devices, as noted

The control system 218 also facilitates communication and socialization among vehicle occupants. Occupants can use the system to interact with one another in a variety of ways. Occupants can also collaborate and share information, such as by creating shared playlists or participating in interactive games. Face to face interactions between occupants in different rows of the vehicle are also facilitated by leveraging displays and cameras both in the console and in other locations throughout the vehicle.

In at least some implementations, the control system 218 and virtual assistant programming may also carry out some tasks when an occupant is not in the vehicle 10. By way of one non-limiting example, the control system 218 may assist in locating items left behind in the vehicle. This may be done by activating one or more cameras 118, 120 having views of the passenger compartment 16, and transmitting the camera(s) image(s) to a remote device 63 (e.g. smartphone) via the vehicle communication device 234. The movable console 66 could also be moved to change the view provided by a camera thereon and improve coverage of the passenger compartment to help locate the missing item. The system could also actuate windows, start the vehicle, actuate the vehicle HVAC-including heated/cooled seats or steering wheel devices, and otherwise prepare the vehicle for a journey.

Further, as shown in FIG. 7, the movable console 66 may also include (e.g. carry, host, communicate with) a robotic arm 250, which can be driven by a robotic arm actuator 252 that may include one or more motors and a robotic arm controller, and the arm may be actuated and moved by the control system 218. The robotic arm 250 can be used to carry out various tasks such as moving items from the console 66 to other places within the vehicle 10, including giving items to occupants or moving items from occupants of the vehicle into the console 66 or a container 82. The arm 252 may also be used to clean the passenger compartment 16, such as by picking up and placing into a receptacle various items that are to be discarded, and/or may include a vacuum attachment to permit vacuuming interior surfaces.

What is claimed is:

1. A vehicle, comprising:
a vehicle body having a passenger compartment including two seats in a front row, the two seats in the front row being spaced apart in a cross-car direction extending between a left side and a right side of the vehicle, and multiple seats in one or more rows spaced from the front row in a fore-aft direction extending between a front and a rear of the vehicle;
a console located in the passenger compartment, at least part of the console being a movable portion that is movable from a first position in which the movable portion is received between the two seats in the front row and a second position in which the movable portion is spaced in the fore-aft direction from the two seats in the front row; and
a control system associated with the console and having a processor and programming executable by the processor, the control system includes a microphone communicated with the control system to enable detection of verbal inputs received by the microphone.

2. The vehicle of claim 1 which also includes an actuator coupled to the movable portion to move the movable portion within the passenger compartment.

3. The vehicle of claim 2 wherein the control system is associated with the actuator to permit control of the actuator via the control system.

4. The vehicle of claim 1 wherein the control system includes one or both of a first video device and a first audio device, and the programming is arranged so that the control system can provide voice-responsive use of the one or both of the first video device and the first audio device.

5. The vehicle of claim 4 which includes one or both of a second video device and a second audio device, wherein the one or both of the second video device and the second audio device are arranged for use by a passenger in the front row.

6. The vehicle of claim 5 wherein the console includes a display and wherein the second video device is communicated with the display.

7. The vehicle of claim 5 wherein the first audio device and the second audio device include both an audio input and an audio output to permit two-way audible communication between the first audio device and the second audio device.

8. The vehicle of claim 1 wherein the movable portion includes a storage compartment in which an item may be placed for movement with the movable portion.

9. The vehicle of claim 1 which also includes a communication device communicated with the control system and arranged to permit wireless communication between the vehicle and a remote source.

10. The vehicle of claim 9 wherein the control system is connectable with the internet via the communication device or a remote device that is coupled to the control system.

11. The vehicle of claim 1 which also includes a container that is selectively connectable with the movable portion of the console for movement with the movable portion of the console.

12. The vehicle of claim 11 which also includes a cargo compartment separated from the passenger compartment by a divider, and wherein the container is movable from the passenger compartment into the cargo compartment through an opening in the divider, and wherein the container is driven by an actuator that is communicated with and controllable by the control system.

13. The vehicle of claim 1 which also includes a vehicle system, and the control system is communicated with the vehicle system and the programming is arranged to enable voice-activated control of the vehicle system via the control system.

14. The vehicle of claim 13 wherein the vehicle system includes an audio device, a video device, or a heating and cooling system.

15. The vehicle of claim 1 wherein the control system provides a virtual assistant interface that is usable by a vehicle occupant through voice commands.

16. A vehicle control system, comprising:
a console located in a passenger compartment of a vehicle, at least part of the console being a movable portion that is movable within the passenger compartment;
a control system associated with the console and having a processor and programming executable by the processor, the control system includes a microphone communicated with the control system to enable detection of verbal inputs received by the microphone;
a communications unit that is communicated with the control system, the communications unit arranged to receive information at the vehicle and to transmit information from the vehicle; and
a backend portion of a cloud-based system, wherein the backend portion includes a processor and memory with programming, wherein the control system includes programming to permit voice-responsive control of one or more vehicle systems, or voice-responsive communication with the backend portion for access to the programming of the backend portion.

17. The system of claim 16 which also includes an actuator coupled to the movable portion to move the movable portion within the passenger compartment, and wherein control system is associated with the actuator to permit control of the actuator via the control system.

18. The system of claim 16 wherein the control system includes one or both of a first video device and a first audio device, and the programming is arranged so that the control system can provide voice-responsive use of the one or both of the first video device and the first audio device.

19. The system of claim 18 which includes one or both of a second video device and a second audio device, wherein the one or both of the second video device and the second audio device are arranged for use by a passenger in the front row.

20. The system of claim 19 wherein the console includes a display and wherein the second video device is communicated with the display.
